(19) United States
(12) Patent Application Publication
(10) Pub. No.: US 2009/0262242 A1
(43) Pub. Date: Oct. 22, 2009

(54) SYSTEM AND METHOD FOR DISPLAY DEVICE OPERATION SYNCHRONIZATION

(75) Inventor: Guillermo Castano, Colonia la Presa (MX)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Minato-ku (JP); SONY ELECTRONICS INC., Parkridge, NJ (US)

(21) Appl. No.: 12/107,215

(22) Filed: Apr. 22, 2008

(51) Int. Cl. H04N 7/00; H04N 5/44

(52) U.S. Cl. 348/462; 348/461; 348/468; 348/734; 348/E07.001; 348/E05.096

(57) ABSTRACT

A system and method for controlling an audio/video display device. The method includes receiving a data signal which is a portion of a content signal received by the audio/video display device and extracting encoded information from the data signal. The method further includes interpreting the encoded information to determine a corresponding display device control code. The display device control code can then be issued to the audio/video display device to automatically implement an operation thereon contemporaneous to display of content associated with the content signal.

### FIELD OF THE INVENTION

Embodiments of the present invention are generally related to display devices and systems such as televisions.

### BACKGROUND OF THE INVENTION

As display technologies have advanced, more and more features are added to differentiate various display devices and televisions. With the increasing shift to High Definition content, televisions have become increasingly advanced with a correspondingly increased set of features such as advanced audio.

As a result of the large number of features and combinations of the features, product demonstrations have become increasingly involved. Normally, special demonstration material is prepared which can be demonstrated to a potential purchaser of the television by a store sales person. Unfortunately, a demonstration by a sales person requires familiarity with the numerous features of the television and the sales person to be available to demonstrate the television. Without the sales person, a potential purchaser will only see the content but be unable to experience the various features of the television.

Further, the sales person must be able to time the demonstration of features according the content displayed on the television. For example, in order to demonstrate a high definition audio output, the sales person would need to be aware of the appropriate points in the content when the advanced audio features should be off and when the advanced audio features should be on.

### SUMMARY OF THE INVENTION

Thus, a need exists for a way to demonstrate the various features of a television or other display device without requiring human interaction. Further, that demonstration of features needs to be synchronized with the content corresponding to the features. Embodiments of the present invention provide a way to automatically control a display device via the content being rendered therein. Embodiments of the present invention further can synchronize settings of a display device (e.g., television set) with the content being rendered thereon.

In one embodiment, the present invention is implemented as a method for controlling a display device (e.g., television, monitor, etc.). The method includes receiving a data signal which is a portion of content received by the display device and extracting encoded information from the data signal. The method further includes interpreting the encoded information to determine a corresponding display device control code. The display device control code can then be automatically issued to a display device in synchronization with the content. The display device then automatically carries out the command corresponding to the display device control code while displaying content. In such a fashion, a piece of demonstration content can automatically configure the display device to take advantage of the features that are being highlighted by the demonstration content.

In another embodiment, the present invention is implemented as a system for controlling a display device. The system includes a data signal receiver for receiving a data signal from a content signal, the data signal comprising encoded control information (e.g., remote control code) and an interpretation module for interpreting the encoded control information. Based on the interpretation of encoded control information, display device control information is determined. The system further includes a control signal communication module operable to transmit the display device control information to the display device for automatic configuration therefore in synchronization with the display and audio rendering of the content signal.

In this manner, embodiments of the present invention implement a way for control information to be encoded within content and issued to the display device. Thus, content (e.g., product demonstration) can be synchronized with adjustment of pertinent display device features or settings. Further, control information can adjust settings to match the content to enhance the user experience (e.g., a cinema mode for a movie) and highlight features to the television model.

In another embodiment, the present invention is implemented as a method for displaying content on a display device (e.g., television). The method includes receiving content comprising audio and video information and encoded information and determining a control signal based on the encoded information. Based on the control signal, a television operation corresponding to the control signal is automatically performed. Content is then displayed on the display device and audio rendered thereon.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary signal diagram in accordance with one embodiment of the present invention.

FIG. 2 shows an exemplary system in accordance with one embodiment of the present invention.

FIG. 3 shows a block diagram of an exemplary control unit in accordance with one embodiment of the present invention.

FIG. 4 shows an exemplary communication diagram in accordance with one embodiment of the present invention.

FIG. 5 shows a flowchart of an automated process for controlling a display device in accordance with one embodiment of the present invention.

FIG. 6 shows a flowchart of an automated process for displaying content on a display device in accordance with one embodiment of the present invention.

FIG. 7 show an exemplary table of control codes in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

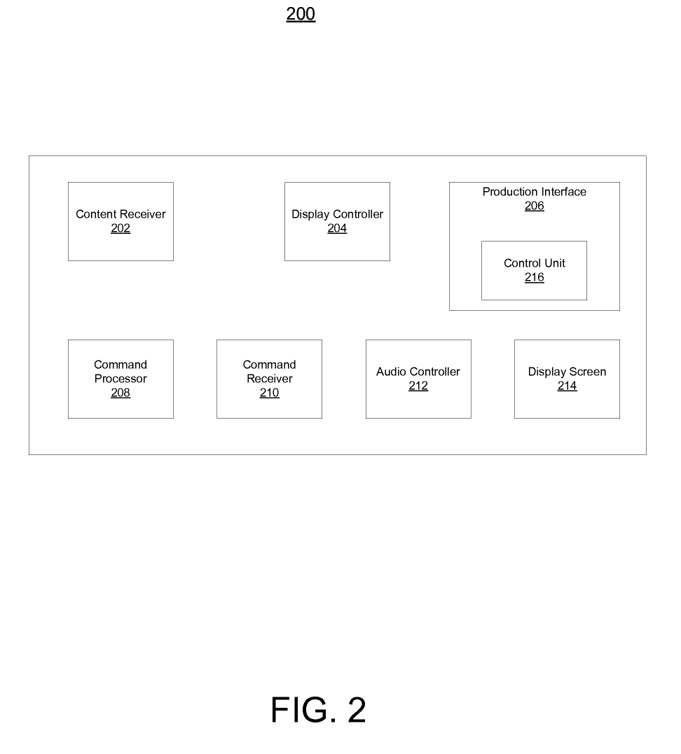

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., display device 200 of FIG. 2), or similar electronic computing device, that manipulates and transforms data represented as physical (electronic) quantities within the computer system's registers and memories into other data similarly represented as physical quantities within the computer system memories or registers or other such information storage, transmission or display devices.

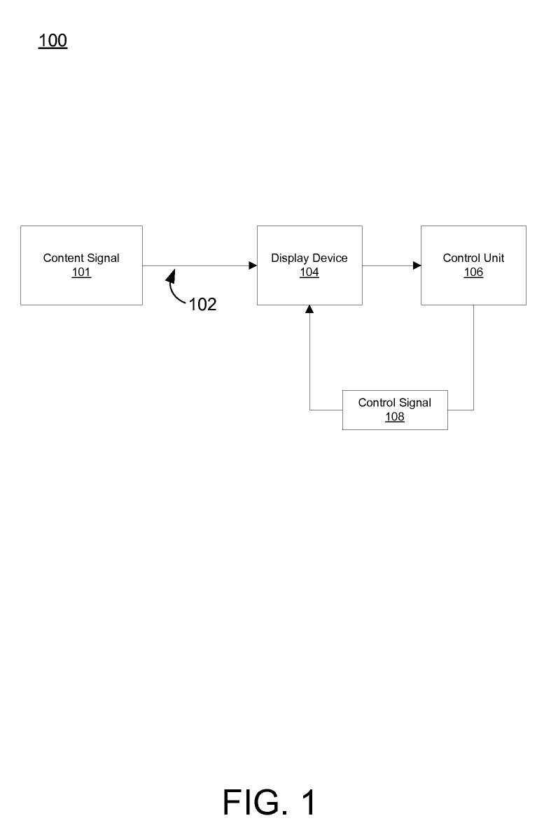

FIG. 1 shows an exemplary signal diagram in accordance with one embodiment of the present invention. Signal diagram 100 includes content source 101, an audio/video display device “display device” 104 (e.g., a television system), control unit 106, and control signal 108.

Content signal 102 is received and processed by display device 104. Content signal may include video and audio information portions as well as control and other information such as closed captioning and electronic guide information. Content or portions therefore may then be pulled by control unit 106. In one exemplary embodiment, the same electronic signals that would be used in a production environment for testing a display device may be extracted from the content signal 102 by the control unit 106. These control signals 108 may be used to control display device 104. Thus, a production protocol may be used to request signals (e.g., closed captioning signal) from the display device and the production protocol may also used to send commands to the display device.

Control unit 106 determines what control information is present in the content signal and sends control signal 108 to display device 104. In one exemplary embodiment, control information may be encoded in analog video as closed caption data that can be reviewed by the control unit using the production protocol. The control unit controls the display device in synchronization with the content of the video and audio rendered. In one embodiment, control signal 108 is coded like a remote control signal. Thus, the communication between control unit 106 and display device 104 may mimic the use of a remote control. For example, control signal 108 can call a menu and navigate through options to invoke features of the display device in much the same ways as a normal user with remote control can.

In one embodiment, display device 104 may send an acknowledge signal to control unit 106 confirming that the command (e.g., control signal 108) was received and/or that the command has executed successfully.

Control unit 106 may further be coupled to a home theatre system and customize the settings of display device 104 to provide the most appropriate settings for display device 104 including, among other things, both the audio and video output.

In this fashion, embodiments of the present invention implement a way for a received content signal to automatically control display device features or settings. Thus, turning on or off display device features can be synchronized with content to enhance the rendering of the content and to facilitate automated demonstrations. For example, a successful demonstration could synchronize the video and audio with the display device turning on/off features which allows potential customers to experience the difference and truly appreciate the value of the features of the display device. Further, the present invention provides a relatively easy to implement, inexpensive, and customizable way for features of a display device or other devices to be automatically controlled.

FIG. 2 illustrates example components used by various embodiments of the present invention. Although specific components are disclosed in system 200 it should be appreciated that such components are examples. That is, embodiments of the present invention are well suited to having various other components or variations of the components recited in system 200. It is appreciated that the components in system 200 may operate with other components than other those presented, and that not all of the components of system 200 may be required to achieve the goals of system 200. It is appreciated that embodiments of system 200 include a variety of devices, including but not limited to televisions, Cathode ray tube (CRT) displays, computer monitors, Liquid crystal displays (LCDs), plasma displays, projection displays, projectors, portable devices, and handheld devices, etc.

FIG. 2 shows an exemplary system in accordance with one embodiment of the present invention. System 200 shows an exemplary display device. System 200 includes content receiver 202, display controller 204, production interface 206, command processor 208, command receiver 210, and audio controller 212.

Content receiver 202 receives content for system 200. Receiver 202 may receive signals including content from a variety of sources including, but not limited to, computers, computer networks, portable devices, set top boxes, over the air broadcasts, cable broadcasts, satellite broadcasts, Digital versatile Discs (DVDs), Blu-ray dics, Digital Video Broadcasting—Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), and Internet Protocol Television (IPTV), etc.

Display controller 204 controls the display of system 200. Display controller 204 may control a variety of display screen 214 associated with system 200, including but not limited to, CRT, LCDs, plasma displays, projection based, and Digital Light Processing (DLP) displays.

Production interface 206 facilitates testing during manufacturing of system 200. For example, production interface 206 may allow automated testing of display device features to assist in efficient manufacturing. In one embodiment, production interface 206 provides access to or interfaces with control unit 216 which facilitates control of a display device (e.g., system 200). Control unit 216 receives content or a portion of content (e.g., received via content receiver 202) including commands encoded in the content. For example, the commands may be remote control commands encoded in a closed captioning (CC) stream. Control unit 216 may extract the encoded commands and forward the commands to command processor 208 (e.g., via command receiver 210).

Command receiver 210 receives commands. Command receiver 210 may receive commands via a variety of receivers including, but not limited to, infrared receivers and radio frequency receivers. The commands may have been issued via remote control (e.g., infrared) or a control unit 216(e.g., a module for performing testing via production interface 206.

Command Processor 208 processes commands received by system 200 via command receiver 210. The commands received are processed and executed by system 200. For example, control codes may be received by via an infrared receiver, decoded, and sent to the command processor 208.

Audio controller 212 controls audio output for system 200 including a variety of outputs including, but not limited to, 2, 2.1, 3.1, 5.1, 6.1, 7.1, and 8.1 channel audio. The audio content may be received via content receiver 202. It is appreciated that audio controller 212 may output to audio equipment integrated within system 200.

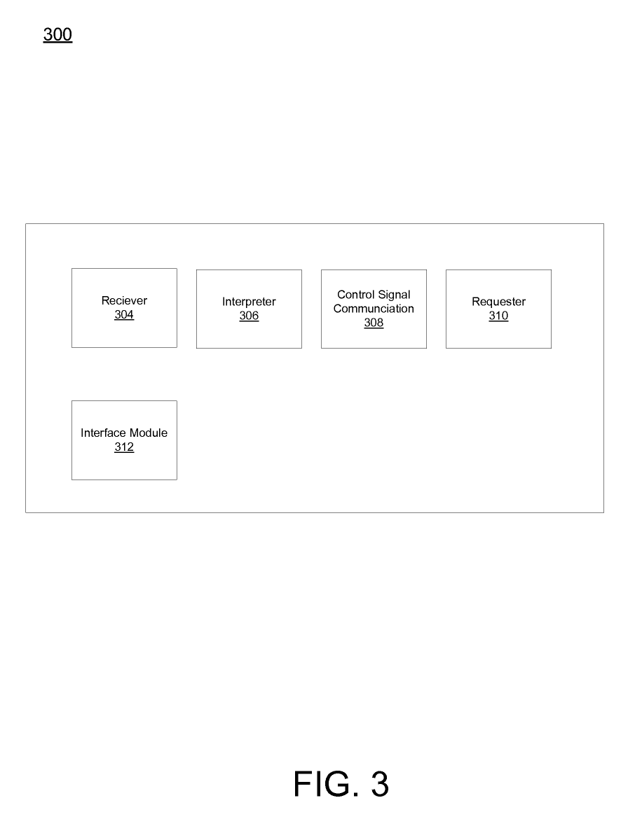

FIG. 3 shows a block diagram of an exemplary control unit (e.g., control unit 216) in accordance with one embodiment of the present invention. System 300 facilitates control of a display device. In one embodiment, system 300 may be a circuit board with a small microprocessor. System 300 may further be used to expand the capabilities of a display device to customized the display device with features not originally present in the base software. It is appreciated that system 300 may be integrated into a display device or be coupled to a display device and a content source (e.g., cable receiver, antenna, and the like). System 300 may further be coupled to a display device via a production port. The production port may be used during manufacturing to automate testing, verifying proper functioning of a display device. It is appreciated that system 300 may also facilitate control of a display device in a commercial location (e.g., a hotel or retail store). System 300 includes receiver 304, interpreter 306, control signal communication module 308, requester 310, and interface module 312.

Interface module 312 may facilitate communication of control unit 300 with a display device (e.g., display device 200). Interface module 312 facilitates: receiver 304 receiving content; request module 310 issuing requests to a display device; and control signal communication module 308 transmitting display device control information to a display device.

In one embodiment, interface module 312 is operable to interface with a production port of a display device. A production port may facilitate product adjustment and inspection of the display device during manufacturing. The production port may facilitate communication in a stand by mode. The production port may further provide a stand by voltage. In one embodiment, the production port may be a serial universal asynchronous receiver/transmitter (UART).

Control unit 300 may be coupled to the display device at the back of display device or via connector on the display device (e.g., an RJ11, RJ45, Universal Serial Bus (USB), wireless networks, Ethernet, Internet Protocol (IP), coaxial cable, etc.). Control unit 300 may communication with a display device via a serial protocol (e.g., RS232).

In one exemplary embodiment, the production port may support hotel features including, but not limited to, having a television tune to a particular channel with a particular channel with a particular channel with a particular initial volume on power on, disabling menu and front keys, limiting the remote control functions that can be accepted, allowing control of operation of a display device though a hotel's control system, and supporting pay per view.

Receiver 304 may receive signals from a display device including content from a variety of sources including, but not limited to, computers, computer networks, DVDs, portable devices, set top boxes, cable, satellites, over air broadcasts, Digital Video Broadcasting—Handheld (DVB-H), Digital Multimedia Broadcasting (DMB), Digital Video Broadcasting Satellite services to Handhelds (DVB-SH), Digital Audio Broadcasting (DAB), and Digital Video Broadcasting IP Datacasting (DVB-IPDC). It is appreciated that control unit 300 may receive only a portion of the content signal received by a display device. In one embodiment, receiver 304 is operable to receive a data signal within the content signal, the data signal including coded control information.

Requester module 310 issues requests to a display device for content or a portion thereof. In one embodiment, requester module 310 requests the Extended Data Service (XDS) portion of a closed captioning (CC) signal which includes encoded control information.

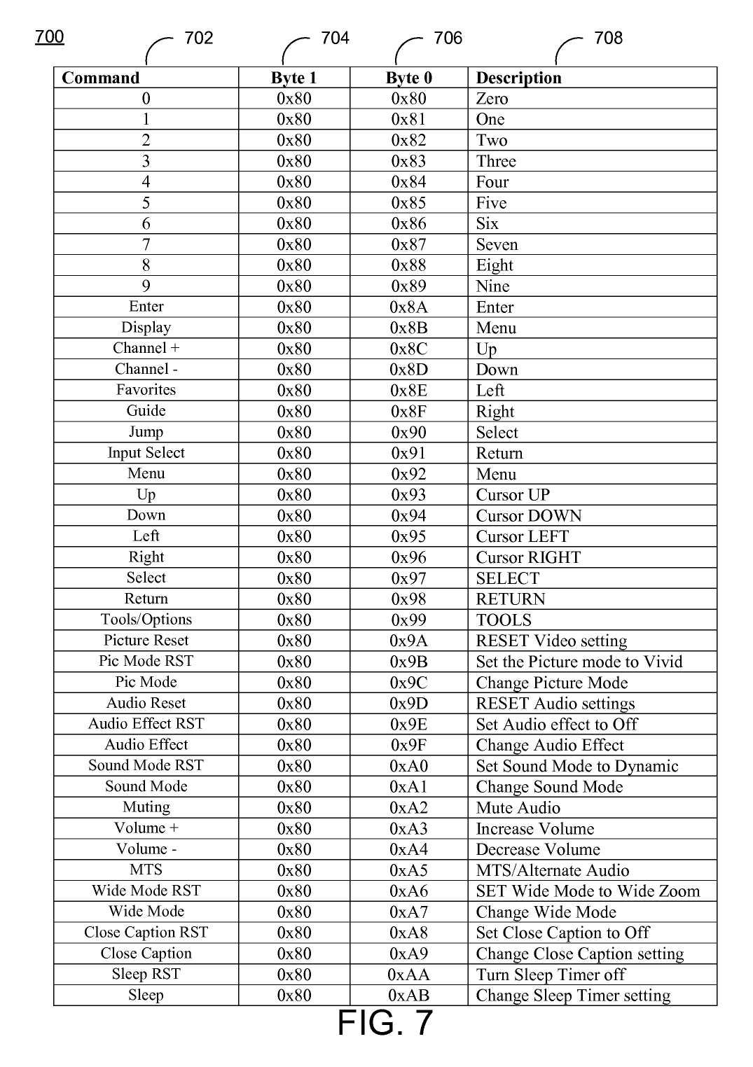

In one embodiment, interpretation module 306 may read the current status of the Parental control section of the XDS closed caption stream, as known as “V-CHIP”. The parental control elements of the XDS are encoded on two bytes of information. Normally ratings are encoded in accordance with the Parental Control Guidelines of EIA-608 and embodiments of the present invention take advantage of the 128 of the two bytes possibilities to create a custom navigation process to set display device features (e.g., as shown in FIG. 7).

Embodiments of the present invention may utilize the CC signal in an analog signal or digital signal for encoding control information therein. CC signal may follow Electronic Industries Alliance (EIA) 608 protocol (a.k.a. line 21 captions, the standard for closed captioning for NTSC TV broadcasts). For ATSC and/or Quadrature Amplitude Modulation (QAM) tuner broadcasts, Program and System Information Protocol (PSIP) and/or EIA-708 captioning protocol may be used convey control information. For example, PSIP headers may be used to transmit encoded control information via a digital broadcast (e.g., via High-Definition Multimedia Interface (HDMI)). It is appreciated that other closed captioning protocols or other protocols in digital and/or analog formats/signals can be used or other signaling streams included in video or audio content to carry control information. Thus, content production can be done with standard equipment to insert the appropriate closed caption codes.

Interpretation module 306 interprets the encoded control information within in the CC signal and determines display device control information corresponding to the encoded control information. The display device control information may include remote control signal encoded data (e.g., remote control code). For example, the display device information may include a variety of commands including, but not limited to, calling a menu, selecting menu items, turn picture on and off, changing volume, changing channel, brightness, contrast, white balance, picture settings, zoom, color mode, sound mode, picture mode, surround sound, invoking a channel guide, input selection, resolution setting, and selection of letter box of wide screen mode. It is appreciated that a display device could have a feature which allows a user to turn off automatic settings by a control unit (e.g., control unit 300).

The display device control information may include information for customizing settings according to content being contemporaneously received via the content signal. For example, the display device control information may include settings that correspond to how a movie was filmed and the display device control information indicates a cinema mode should be enabled and may be further customized according the filming techniques used in making the movie. Audio settings can also be established and set according to the content. It is appreciated that embodiments of the present invention may automatically enable settings or modes from encoded data to facilitate a better experience.

Based on the display device information determined by interpretation module 306, control signal communication module 308 transmits the display device control information to the display device. In one embodiment, control signal communication module 308 may simulate a remote control signal (e.g., an infrared remote control signal).

The display device control information may be electronic signals, infrared codes, radio frequency codes, or other codes used by the display device to receive commands. The use of the same codes allows a control unit to operate the device without modification of the display device. The codes may be inserted into a signaling stream to a command processor (e.g., command processor 108) to automatically implement the codes in synchronization with the content contemporaneously displayed and audibly rendered. In another embodiment, an infrared or radio frequency transmitter could be used to communicate commands.

The display device control information may further include information for a first set of display device settings and a second set of display device settings. In one exemplary embodiment, a demonstration content source (e.g., movie) may include the first setting with a surround sound feature disabled and a second setting with the surround sound feature enabled. Thus, when video starts a particular scene that explains the capabilities of the Dolby Prologic II stadium Mode, the encoded closed caption stream will be read by a control unit and will turn on the menu and navigate the menu to set the proper display device settings. The video can be describing what happens at the same time (e.g., via CC text). In one embodiment, the display device may be coupled to a content source via Composite or component video on a 480 i resolution. It is appreciated that other connections (e.g., DVI, HDMI) and other resolutions (e.g., 720 p, 1080 i, 1080 p) may be used.

Embodiments of the present invention thus allow the preparation of a video with scenes and corresponding settings for the display device to output the audio and video in a customized manner corresponding to the scene.

Advantageously, the demonstration or content may be changed, edited, and improved as needed. The demonstration requires no human interaction and therefore removes the potential for miss operation by a user. Further, the process can be controlled in a physical way (e.g. disconnecting the content source) without the need for passwords and other complicated security processes.

In one embodiment, a plurality of control units could be networked to receive content on various different model display devices (e.g., different screen sizes, feature sets, etc.) in a commercial environment (e.g., retail store) to provide automated demos according to the capabilities of each model.

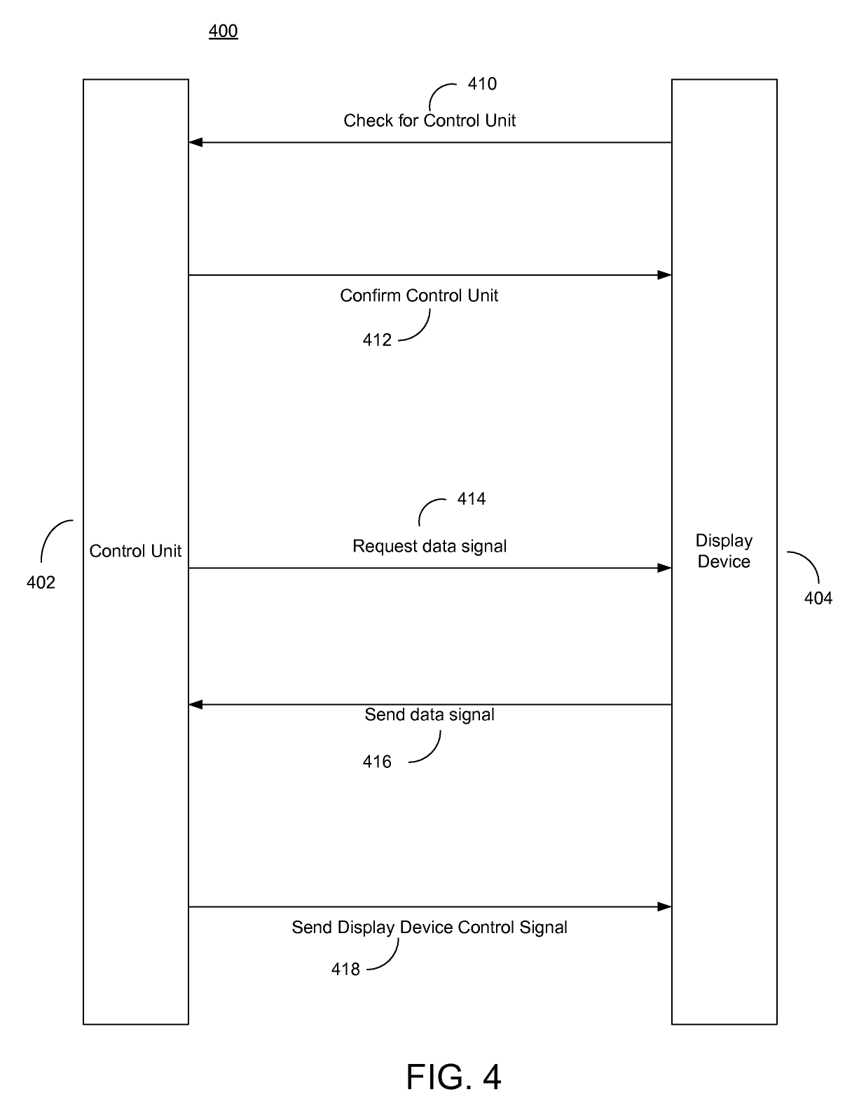

FIG. 4 shows an exemplary communication sequence 400 between a display device 404 (e.g., display device 200) and control unit 402 (e.g., control unit 300) in accordance with one embodiment of the present invention. It is appreciated that the communications between display device 404 and control unit 402 may occur via a variety of interfaces or communication ports including, but not limited to, a production port, a hotel port, an Ethernet port, RJ11, etc.

At step 410, display device 404 sends a signal to check for the presence of a control unit. In one exemplary embodiment, the signal to check for the presence of a control unit may be issued as part of or just after powering on display device 404.

At step 412, the control unit 402 responds confirming the presence of the control unit. The confirmation may be used by display device 404 to prepare to process content signals for providing to control unit 402.

At step 414, control unit requests a data signal from display device 404 (e.g., via requester 310). In one embodiment, control unit 402 requests an XDS portion of a CC signal as described herein. The CC signal may be extracted from a received content signal.

At step 416, display device 404 sends a data signal in response to the request from control unit 402. In one embodiment, control unit 402 receives the XDS portion of the CC signal.

At step 418, control unit 402 sends a display device control signal. In one embodiment, control unit 402 sends a simulated remote control signal to display device 404. It is appreciated that as content is received by display device 404 portions thereof may be sent to control unit 402 which may respond with display device control signals and thus steps 416 and 418 may repeat throughout the display of content on display device 404. In this fashion, the display device is configured contemporaneously with content rendered on the device.

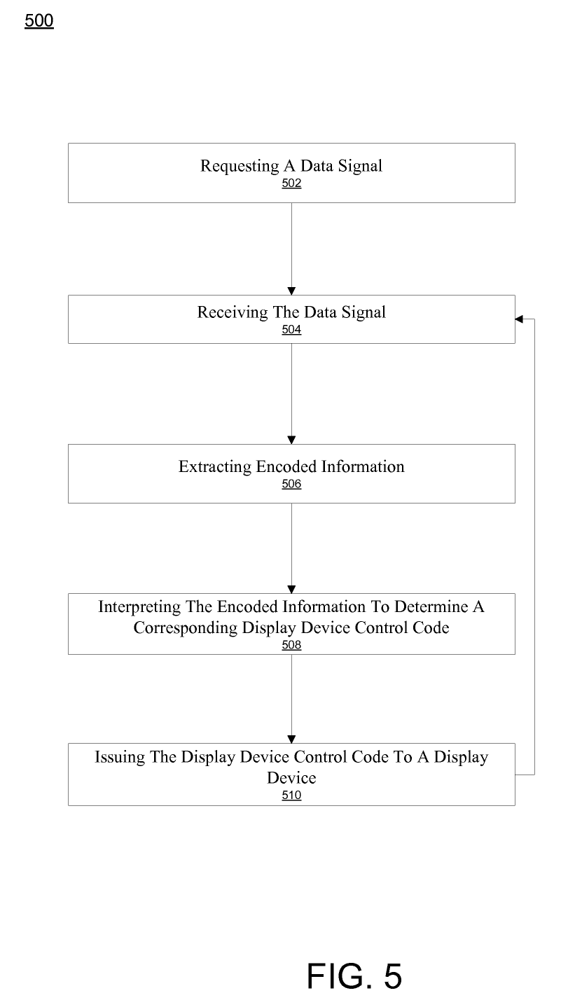

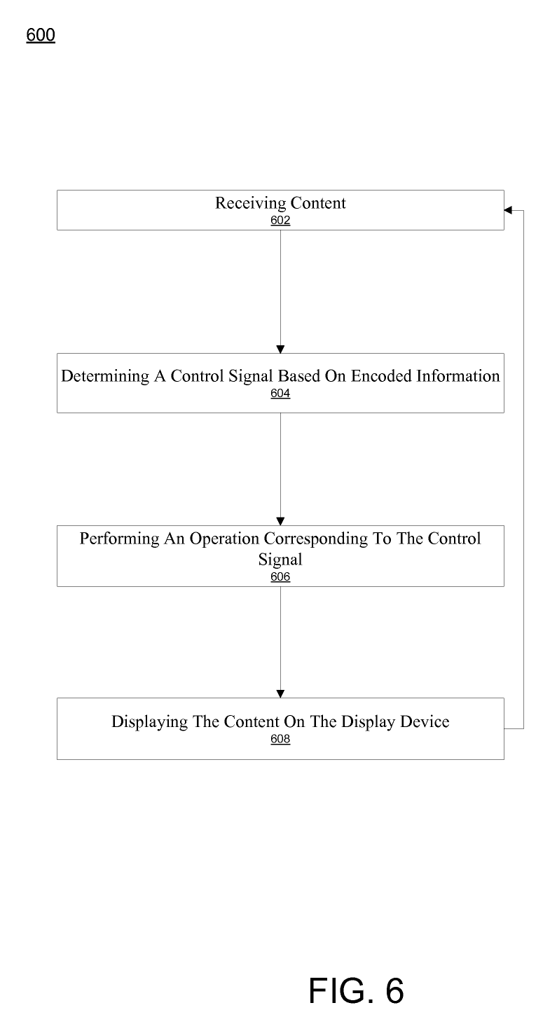

With reference to FIGS. 5 and 6, flowcharts 500 and 600 each illustrate example functions used by various embodiments of the present invention. Flowcharts 500 and 600 include processes that, in various embodiments, are carried out by a processor under the control of computer-readable and computer-executable instructions. Although specific function blocks (“blocks”) are disclosed in flowcharts 500 and 600, such steps are examples. That is, embodiments are well suited to performing various other blocks or variations of the blocks recited in flowcharts 500 and 600. It is appreciated that the blocks in flowcharts 500 and 600 may be performed in an order different than presented, and that not all of the blocks in flowcharts 500 and 600 may be performed.

FIG. 5 shows a flowchart of a process for controlling a display device in accordance with one embodiment of the present invention. The portions of flowchart 500 may be carried out by a control unit (e.g. control unit 300) via a display device port (e.g. production port).

At block 502, a data signal is requested. The data signal may be a portion of content signal received by a display device (e.g., display device 204) as described herein. For example, the data signal request may be for the XDS portion of a CC signal. The XDS portion of the closed captioning (CC) signal may include encoded information.

At block 504, a data signal is received (e.g., by receiver 304 of control unit 300). For example, as described herein the XDS portion of CC signal may be received.

At block 506, encoded information is extracted from the data signal. The display device control code may include information for adjustment of display device settings corresponding to a portion of the content contemporaneously received by the display device.

At block 508, the encoded information is interpreted to determine a corresponding display device control code as described herein. For example, the display device control code may be encoded as remote control commands and, for instance, may include a remote control code corresponding to a cinema mode.

At block 510, display device control code is issued to a display device. For example, remote control code may an infrared remote control code which is communicated to the appropriate portion of a display device (e.g. command processor 208). Device 208 then automatically implements the settings while displaying and audibly rendering the content.

FIG. 6 shows a flowchart of a process for displaying content on a display device in accordance with one embodiment of the present invention. It is appreciated that the blocks for flowchart 600 may be carried out by a display device (e.g., system 200) including a control unit (e.g., system 300).

At block 602, content is received. The content may be received by a display device and can include audio and video information and encoded information. The encoded information may be of a format matching remote control codes. In one embodiment, the display device is a television and the content signal comprises closed captioning information encoded within a content signal also comprising audio and video signals.

At block 604, a control signal is determined based on the encoded information. As described herein, the control signal may be a remote control code encoded in an XDS portion of CC information.

At block 606, based on the determination of the control signal, an operation corresponding to the control signal is performed. For example, in performing the operation a television may display a menu and select a surround sound mode. The television is therefore automatically configured at block 606.

At block 608, the content is rendered on the display device. For example, the content may be displayed and audibly rendered along with CC text indicating the surround sound feature was just turned on.

FIG. 7 show an exemplary table of control codes in accordance with one embodiment of the present invention. Table 700 shows a possible encoding of information within an XDS portion of a CC stream as described herein. Column 702 includes the command (e.g., a remote control command). Columns 704 and 706 include the first byte and second byte, respectively, as encoded in the XDS information. Column 708 describes the functions associated with the command. It is appreciated that the protocol may be expanded to create more sophisticated control and that other encodings are possible.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for controlling a display device comprising:
accessing a data signal, wherein said data signal is a portion of a content signal received by an audio/video display device;
extracting encoded information from said data signal;
interpreting said encoded information to determine a corresponding display device control code; and
issuing said display device control code to said audio/video display device to implement an operation thereof.

2. The method of claim 1 further comprising:
requesting said data signal.

3. The method of claim 1 wherein said data signal is a closed captioning (CC) signal.

4. The method of claim 3 wherein an Extended Data Service (XDS) portion of said closed captioning (CC) signal comprises said encoded information.

5. The method of claim 1 wherein said data signal is a Program and System Information Protocol (PSIP) signal.

6. The method of claim 1 wherein said display device control code comprises information for adjustment of display device settings corresponding to contemporaneously rendered content of said content signal.

7. The method of claim 1 wherein said display device control code is a remote control code.

8. The method of claim 7 wherein said remote control code is an infrared remote control code.

9. A system for controlling a television system comprising:
a data signal receiver for receiving a data signal comprising encoded control information said data signal being part of a content signal received by said television system;
an interpretation module for interpreting said encoded control information and determining display device control information corresponding to said encoded control information; and
a control signal communication module operable to transmit said display device control information to the television system for control thereof.

10. A system as described in claim 9 further comprising:
an interface module operable to interface with a production port of said television system.

11. A system as described in claim 9 wherein said display device control information comprises information for a first set of display device settings and a second set of display device settings.

12. A system as described in claim 9 wherein said display device control information comprises information for customizing settings of said television system according to content for contemporaneous rendering on said television system.

13. A system as described in claim 9 wherein said data signal comprises Closed Captioning (CC) information.

14. A system as described in claim 13 wherein an Extended Data Service (XDS) portion of said closed captioning (CC) signal comprises said encoded control information.

15. A system as described in claim 9 wherein said display device control information comprises a remote control signal.

16. A system as described in claim 9 further comprising:
a requester module for requesting said data signal from said television system.

17. A method for displaying content on an audio/video display device comprising:
receiving a content signal comprising audio and video information and encoded information;
determining a control signal based on said encoded information;
based on said determining of said control signal, automatically performing an operation on said audio/video display device corresponding to said control signal; and
displaying said audio/video information on said audio/video display device in accordance with said operation.

18. A method as described in claim 17 wherein said audio/video display device is a television and said content signal comprises Closed Captioning (CC) information.

19. A method as described in claim 18 wherein said CC information comprises an extended data service (XDS) portion comprising said encoded information.

20. A method as described in claim 17 wherein said control signal comprises a remote control signal.
